(19) United States
(12) Patent Application Publication
(10) Pub. No.: US 2004/0133684 A1
(43) Pub. Date: Jul. 8, 2004

(54) Method and device for l2tp reconnection handling

(76) Inventors: Kwang Mien Chan, Singapur (SG); Senthil Kumar, Singapur (SG); Yong Shyang Liaw, Singapur (SG); Joshua Seng ARN Liew, Singapur (SG); Gernot Reuss, Munchen (DE); Hartmut Schuler, Strasslach (DE); Winston Khoon Guan Seah, Singapore (SG); Kean Soon Tan, Singapur (SG)

Correspondence Address: MORRISON & FOERSTER LLP, 1650 TYSONS BOULEVARD, SUITE 300, MCLEAN, VA, 22102, US

(21) Appl. No.: 10/471,141

(22) PCT Filed: Jan. 31, 2002
(86) PCT No.: PCT/DE02/00342

(30) Foreign Application Priority Data
Mar. 9, 2001 (DE) 101 11 493.1

(51) Int. Cl. G06F 15/16

(52) U.S. Cl. 709/227; 709/249

(57) ABSTRACT

The aim of the invention is to improve the connection between a mobile terminal (MH) and a network server (LNS) on the pan of an Intranet, in particular for the transmission of large files, despite terminations of the connection. To achieve this in a suitable manner, a device and a method are provided for establishing a connection (MH-LNS) from a mobile terminal (MM to a network server (LNS) via a mobile radio network (GSM, RAS/LAC and an additional network (Internet). According to said method, when a connection from the mobile terminal (MH) to the network server (LNS) is interrupted (disconnect), part of the connection (between the PEP and LNS), between the connection server (PEP) and do network saver (LNS) is maintained, said part of the connection (PEP/LNS) forming part of the connection (MH-LNS) between the mobile terminal (MH) and the network server (LNS). When a subsequent new connection is established between the mobile terminal (MH) and the network server (LNS), the part of the interrupted connection (PEP-LNS) that was maintained becomes part of doe connection to be subsequently established.

The invention relates to a method of establishing a connection between a mobile terminal and a network server via a mobile radio network and an additional network, e.g. internet-protocol based network.

The aim of the invention is to allow, as simply and efficiently as possible, establishment of a new connection when a (previous) connection between a mobile terminal and a network server in a network is interrupted. This object is achieved by each of the subjects of the independent claims.

According to the invention, a connection between a mobile terminal and a network server (for instance a company intranet or other private network) which is routed via a mobile radio network and an internet-protocol based network can be re-established very quickly after an interruption (e.g. of a radio link). Re-assigning an internet protocol address (of the mobile terminal) used in the previous (interrupted) connection between the mobile terminal (mobile host) and the network server which is made possible in accordance with the invention for the session after establishing a new connection between the mobile terminal and the network server avoids losses which would otherwise occur without this facility; in particular, if a connection between the mobile terminal and the network server is interrupted while transmitting a large amount of data, for instance a large file, this avoids having to assign the mobile terminal a new internet address and having to send the file again in its entirety because, advantageously, the old internet address of the interrupted connection can be re-assigned to the mobile terminal (by the connection server) and the connection server can maintain a connection between the mobile terminal and the network server using the old address.

The mobile terminal can be any mobile terminal which is suitable for data transmission via a mobile radio network, especially a mobile terminal (MH) which is suitable for packet data transmission. The network server (LNS) within the meaning of the claims can be the server which is used to connect a server on the part of the mobile radio network (through which mobile terminal MH phones) via a connection (in this case a tunneling connection, especially an L2TP connection). The connection server (PEP, Performance Enhancing Proxy) maintains, in accordance with the invention, part of the connection between the mobile terminal and the network server if the connection is interrupted at any point, namely the part of the connection between it (the connection server) and the network server.

Further aspects and advantages of the invention will become apparent from the claims and the following description of an exemplary embodiment, reference being made to the accompanying drawings:

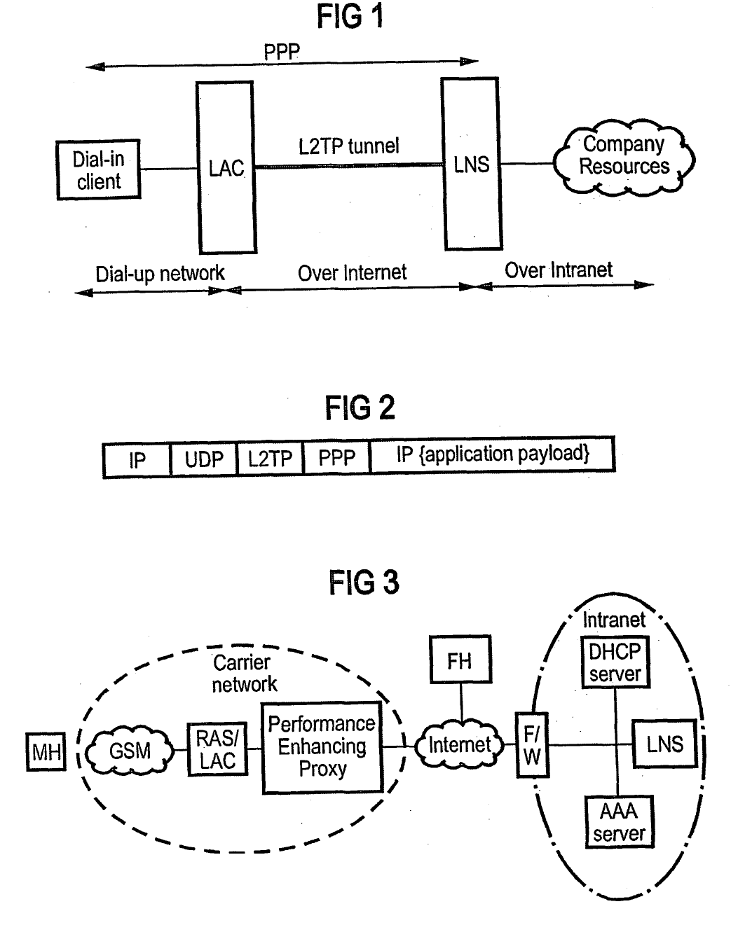

FIG. 1 Block diagram of a virtual private network with a point-to-point connection using an L2TP tunneling protocol,

FIG. 2 Header in a data packet transmitted using an L2TP tunnel via an IP network,

FIG. 3 Schematically shows a connection in accordance with the invention between a mobile terminal and a network server via a mobile radio network, a connection server and an internet-protocol based network.

FIG. 1 shows a mobile terminal (dial-in client) which is connected via a dial-up network to one end (LAC, L2P Access Concentrator) of an L2TP tunnel, the other end of which is connected to a network server (LNS=L2TP Network Server) to which a private network (for instance a “Company Resources' corporate network or intranet) is connected. This creates a point-to-point protocol (PPP) connection between the mobile terminal (client) and the network server (LNS) via a dial-up network (e.g. a mobile radio network) and (by an L2TP tunnel between LAC and LNS) an internet-protocol based network (e.g. internet).

FIG. 2 shows, by way of example and for such a tunneling protocol, one possible structure in the L2TP tunnel of a data packet transmitted from the mobile terminal (client) to the network server (or the private network/intranet connected through it). The data packet contains the data to be transmitted (IP, Application Payload) and several headers which can be used for onward routing the data packet, namely an IP header used for transmission via an internet-protocol based network (internet in FIG. 3), a User Datagram Protocol header (UDP) (which is not relevant in this respect in order to understand the invention), an L2TP header which is relevant for transmission in the L2TP tunnel and a PPP header (point-to-point header) which can be used for point-to-point transmission from the mobile terminal (client, MH).

FIG. 3 illustrates one possible architecture of a transmission method or network according to the invention. Data is transferred from a mobile terminal (MH) via any mobile radio network (GSM, GPRS or 3G or any other mobile radio networks) to a network server (LNS) on the part of a private network or intranet. Data originating from mobile terminal MH via a mobile radio network (GSM etc.) is transmitted by a network server LAC on the part of the Radio Access System of the mobile network (GSM) via a tunneling protocol (in this case L2TP) to a network server (LNS) of a private network/intranet. Transmission takes place partially over an internet-protocol based network (in this case the internet). Having to re-establish the entire connection between mobile terminal MH and the LNS network server in the event of a connection between mobile terminal MH and network server LNS being interrupted (for instance due to interference on the radio link between the mobile terminal and Radio Access System (RAS) in the event of a dead spot, etc.). This is time-consuming because of the time needed to establish a new connection.

In addition, previous solutions involved assigning a new internet protocol address to the mobile terminal which meant that, if the connection was interrupted while a large quantity of data was being transmitted (downloading a file from the network server to the mobile terminal, for instance downloading e-mail, FTP file transfers, etc.) all the data (including previously transmitted data) had to be re-transmitted in its entirety.

This is, however, avoided by the connection server PEP (Performance Enhancing Proxy) according to the invention which, if the connection between the mobile terminal (e.g. on the GSM mobile radio link, etc.) and the connection server PEP according to the invention is interrupted, maintains the tunneling connection between connection server PEP and network server LNS over the internet when establishing a new connection (e.g. requested by mobile terminal MH) assigns a new internet address to the terminal for the new connection (between the terminal and the connection server) and then assigns the internet protocol address (or other address) to the mobile terminal which it used in the previously interrupted connection to network server LNS, thus making it possible for the mobile terminal to continue the old session (the interrupted previous connection) with the network server. Because the mobile terminal can continue to use the same internet protocol address, a file which was partially transmitted before the connection was interrupted can be completely transmitted because only the remainder of the file needs to be transmitted. In order to prevent the connection between connection server PEP and network server LNS being interrupted, PEP can also intercept messages (e.g. Call Disconnection Notification (CDN)) sent by the mobile radio network or LAC in the event of the connection to mobile terminal MH being

interrupted in order to prevent network server LNS initiating connection clear-down. It is also feasible for connection server PEP (Performance Enhancing Proxy) to pretend, by sending messages to network server LNS, that mobile terminal MH is still connected to the connection server.

1. Method of establishing a connection (MH-LNS) from a mobile terminal (MH) to a network server (LNS) over a mobile radio network (GSM, RAS/LAC) and an additional network (internet),
whereby if a connection from mobile terminal (MH) to network server (LNS) is interrupted, a part (between PEP and LNS) of the connection between connection server (PEP) and network server (LNS) is maintained, this part (PEP/LNS) of the connection being part of connection (MH-LNS) between mobile terminal (MH) and network server (LNS),
whereby if a new connection is subsequently established between mobile terminal (MH) and network server (LNS), the maintained part (PEP-LNS) of the interrupted connection becomes part of the new connection.

2. Method as claimed in claim 1, characterized in that the connection (MH-LNS) between mobile terminal (MH) and network server (LNS) or the connection (MH-LNS) between connection server (PEP=Performance Enhancing Proxy) and network server (LNS) is a tunneling connection, especially an L2TP tunneling connection.

3. Method as claimed in claim 1 or 2, characterized in that the connection (PEP-LNS) is via the internet.

4. Method as claimed in one of the preceding claims, characterized in that the connection server (Performance Enhancing Proxy), when a connection (MH-LNS) is cleared down, prevents the transmission of information (CDN) relating to clearing (in RAS), especially “L2TP Call Disconnection Notification”, in order to cause network server (LNS) to retain that part of the connection between it (LNS) and the connection server (PEP=Performance Enhancing Proxy).

5. Method as clamed in one of the preceding claims, characterized in that in the event of establishing a new connection caused by a message (Request for Connection) from the mobile terminal (MH), the mobile terminal (MH) is assigned a new address, especially an IP address, causing the new connection to be continued with its previous IP address from the first, interrupted connection.

6. Method as claimed in one of the preceding claims, characterized in that for complete clear-down of the connection between the mobile station (MH) and the network server (LNS)—preferably triggered by mobile terminal (MH)—a timer is started and a message (CDN) is sent to the network server (NMS) once the timer expires.

7. Method as claimed in one of the preceding claims, characterized in that authentication of the mobile terminal (MH) and/or a device on the terminal side (SIM) is processed on the part of the network server (in the AAA server).

8. Method as claimed in one of the preceding claims, characterized in that the connection server for data to be transmitted (FIG. 2) between mobile terminal (MH) and network server (LNS) only works as a name address allocator or NAT with regard to a header (“IP/UDP”) relating to an IP-based network (FIG. 3, internet) but not with regard to the header (FIG. 2 11L2TP, PPP”) relating to the tunnel (FIG. 1 L2TP).

9. Method as claimed in one of the preceding claims, characterized in that the method is used for transmitting large quantities of data and/or files.

10. Method as claimed in one of the preceding claims, characterized in that network node (LNS) makes it possible to dial up from a mobile terminal (MH) into a private network, especially a virtual private network which preferably makes available services (appointments, read e-mails, download data/images) to the terminal (MH).

11. Method as claimed in one of the preceding claims, characterized in that the network (“intranet”) connected to the network server (LNS) is protected against access from the internet by a protected connection (firewall “F/W”).

12. Device to implement the method as claimed in one of the preceding claims.

13. Device (connection server=Performance Enhancing Proxy), especially as claimed in claim 12 for supporting the establishment of a connection between a mobile terminal (MH) and a network server (LNS),
with a transfer device for part of the connection between mobile terminal (MH) and network server (LNS) which is located between the device and the network server (LNS),
with a transmission device for a part of the connection between mobile terminal (MH) and network server (LNS), said part of the connection being located between the mobile terminal (MH) and the device,
with a controller designed so that if a connection from mobile terminal (MH) to network server (LNS) is interrupted, part of the connection (PEP-LNS) between connection server (PEP) and network server (LNS) is maintained, said part of connection (PEP-LNS) being part of the connection (MH-LNS) between mobile terminal (MH) and network server (LNS),
whereby if a new connection is subsequently established between mobile terminal (MH) and network server (LNS) the maintained part of the connection (PEP-LNS) of the previous connection becomes part of the new connection (MH-LNS).

14. Device as claimed in claim 13, characterized in that the connection (MH-LNS) between mobile terminal (MH) and network server (LNS) is a tunneling connection, especially an L2TP tunneling connection.

15. Device as claimed in claim 13, characterized in that the connection (MH-LNS) between connection server (PEP=Performance Enhancing Proxy) and network server (LNS) is a tunneling connection, especially an L2TP tunneling connection.

16. Device as claimed in one of the preceding device claims, characterized in that the connection (MH-LAC) between mobile terminal (MH) and a network server LAC is routed via an air interface of a mobile radio network.

17. Device as claimed in one of the preceding device claims, characterized in that the connection (PEP-LAC) between connection server (PEP=Performance Enhancing Proxy) and network server (LAC) of the mobile radio network is routed via a mobile radio network.

18. Device as claimed in one of the preceding device claims, characterized in that the connection (PEP-LNS) between connection server (PEP=Performance Enhancing Proxy) and network server (LNS=L2TP network server) of the intranet is routed via an IP protocol network, especially the internet.

19. Device as claimed in one of the preceding device claims, characterized in that it is designed so that when a connection (MH-LHS) is cleared down, the connection server (Performance Enhancing Proxy) prevents the transmission of information relating to clear-down (CDN) (in RAS), especially “L2TP Call Disconnect Notification” in order to cause the network server (LNS) to retain that part of the connection between it (LNS) and the connection server (PEP=Performance Enhancing Proxy).

20. Device as claimed in one of the preceding device claims, characterized in that it is designed so that if a new connection is established due to a message (Request for Connection) from the mobile terminal (MH), a new address, especially an IP address is assigned to mobile terminal (MH) causing the new connection to be continued with its previous IP address from the first, interrupted connection.

21. Device as claimed in one of the preceding device claims, characterized in that it is designed so that for complete clear-down of the connection between mobile station (MH) and network server. (LNS)—preferably triggered by the mobile terminal (MH)—a timer is started and a message (CDN) is sent to network server (LNS) once the timer expires.

22. Device as claimed in one of the preceding device claims, characterized in that it is designed so that authentication of the mobile terminal (MH) and/or a device on the terminal side (SIM) is processed by the network server (in the AAA server).

23. Device as claimed in one of the preceding device claims, characterized in that it is designed so that for data to be transmitted (FIG. 2) between mobile terminal (MH) and network server (LNS) the connection server only works as a name address allocator or NAT with regard to a header (“IP/UDP”) relating to an IP-based network (FIG. 3, internet) but not with regard to the header (FIG. 2 “L2TP, PPP”) relating to the tunnel (FIG. 1 L2TP).

24. Device as claimed in one of the preceding device claims, characterized in that it is intended for transmitting large quantities of data and/or files.

25. Device as claimed in one of the preceding device claims, characterized in that the network node (LNS) makes it possible to dial up from a mobile terminal (MH) into a private network, especially a virtual private network which preferably makes services (appointments, read e-mails, download data/images) available to the terminal (MH).

26. Device as claimed in one of the preceding device claims, characterized in that the network (“intranet”) connected to the network server (LNS) is protected against access from the internet by a protected connection (firewall “F/W”).
